(19) United States
(12) Patent Application Publication
(10) Pub. No.: US 2025/0232049 A1
(43) Pub. Date: Jul. 17, 2025

(54) APPLYING DIFFERENT SENSITIVITY LABELS TO DIFFERENT PORTIONS OF CONTENT

(71) Applicant: DELL PRODUCTS L.P., Round Rock, TX (US)

(72) Inventors: Karunakar Palicherla Reddy, Austin, TX (US); Fnu Jasleen, Austin, TX (US); Gandali Pradip Patil, San Antonio, TX (US)

(73) Assignee: DELL PRODUCTS L.P., Round Rock, TX (US)

(21) Appl. No.: 18/413,315

(22) Filed: Jan. 16, 2024

(51) Int. Cl. G06F 21/62; G06F 40/109

(52) U.S. Cl. CPC G06F 21/6209; G06F 40/109; G06F 2221/2111; G06F 2221/2141

(57) ABSTRACT

Techniques for applying different sensitivity labels to different portions of content are described. One example method includes identifying a sensitive portion and a highly sensitive portion of a digital file; receiving a request from a first user to view the digital file; determining that the first user is authorized to view both the sensitive portion and the highly sensitive portion of the digital file; displaying the sensitive portion and the highly sensitive portion of the digital file to the first user; receiving a request from a second user to view the digital file;

determining that the second user is authorized to view the sensitive portion of the digital file but not the highly sensitive portion of the digital file; displaying the sensitive portion of the digital file to the second user; and obfuscating the highly sensitive portion of the digital file from the second user.

### TECHNICAL FIELD

The present disclosure relates in general to information handling systems, and more particularly to techniques for applying different sensitivity labels to different portions of content.

### BACKGROUND OF THE INVENTION

Generally, digital files stored in computer file systems are associated with a set of permissions controlling what users can access each file, and what level of access each user is allowed. These permissions apply to the entirety of the digital file. It is not possible in such systems to grant a user access to only a portion of the content in a digital file, while preventing them from accessing another portion of the content.

### SUMMARY OF THE INVENTION

In accordance with embodiments of the present disclosure, a method for applying different sensitivity labels to different portions of content including identifying a sensitive portion and a highly sensitive portion of a digital file, wherein content in the highly sensitive portion is more sensitive than content in the sensitive portion of the digital file; assigning a highly sensitive label to the highly sensitive portion of the digital file, and a sensitive label to the sensitive portion of the digital file; receiving a request from a first user to view the digital file, the first user associated with a first user context; determining that the first user is authorized to view both the sensitive portion and the highly sensitive portion of the digital file based at least in part on the first user context; displaying the sensitive portion and the highly sensitive portion of the digital file to the first user; receiving a request from a second user to view the digital file, the second user associated with a second user context different than the first user context; determining that the second user is authorized to view the sensitive portion of the digital file and is not authorized to view the highly sensitive portion of the digital file based at least in part on the second user context; displaying the sensitive portion of the digital file to the second user; and obfuscating the highly sensitive portion of the digital file from the second user.

In some cases, obfuscating the highly sensitive portion of the digital file includes displaying a blurred representation of the highly sensitive portion.

In some cases, the first user context includes access privileges that are sufficient for viewing the highly sensitive portion of the digital file, and the second user context includes access privileges that are insufficient for viewing the highly sensitive portion of the digital file.

In some implementations, determining that the second user is not authorized to view the highly sensitive portion of the digital file is based at least in part on an environmental context included in the second user context and indicating that the second user is attempting to view the digital media file from an insecure location.

In some cases, determining that the first user is authorized to view both the sensitive portion and the highly sensitive portion of the digital file is based at least in part on a file context associated with the digital file.

In some implementations, the file context indicates at least one of the first user authoring the digital file, the first user being the owner of the digital file, or that the digital file is shared with the first user.

In some cases, the method further includes receiving a request from a third user to view the digital file, the third user associated with a third user context different than the first and second user contexts; determining that the third user is not authorized to view the sensitive portion or the highly sensitive portion of the digital file based at least in part on the third user context; and obfuscating the sensitive portion and the highly sensitive portion of the digital file from the third user.

In accordance with embodiments of the present disclosure, a system for applying different sensitivity labels to different portions of content is configured to perform operations including identifying a sensitive portion and a highly sensitive portion of a digital file, wherein content in the highly sensitive portion is more sensitive than content in the sensitive portion of the digital file; assigning a highly sensitive label to the highly sensitive portion of the digital file, and a sensitive label to the sensitive portion of the digital file; receiving a request from a first user to view the digital file, the first user associated with a first user context; determining that the first user is authorized to view both the sensitive portion and the highly sensitive portion of the digital file based at least in part on the first user context; displaying the sensitive portion and the highly sensitive portion of the digital file to the first user; receiving a request from a second user to view the digital file, the second user associated with a second user context different than the first user context; determining that the second user is authorized to view the sensitive portion of the digital file and is not authorized to view the highly sensitive portion of the digital file based at least in part on the second user context; displaying the sensitive portion of the digital file to the second user; and obfuscating the highly sensitive portion of the digital file from the second user.

In accordance with embodiments of the present disclosure, an article of manufacture includes a non-transitory, computer-readable medium having computer-executable instructions thereon that are executable by a processor of a computer system to perform operations for applying different sensitivity labels to different portions of content including identifying a sensitive portion and a highly sensitive portion of a digital file, wherein content in the highly sensitive portion is more sensitive than content in the sensitive portion of the digital file; assigning a highly sensitive label to the highly sensitive portion of the digital file, and a sensitive label to the sensitive portion of the digital file; receiving a request from a first user to view the digital file, the first user associated with a first user context; determining that the first user is authorized to view both the sensitive portion and the highly sensitive portion of the digital file based at least in part on the first user context; displaying the sensitive portion and the highly sensitive portion of the digital file to the first user; receiving a request from a second user to view the digital file, the second user associated with a second user context different than the first user context; determining that the second user is authorized to view the sensitive portion of the digital file and is not authorized to view the highly sensitive portion of the digital file based at least in part on the second user context; displaying the sensitive portion of the digital file to the second user; and obfuscating the highly sensitive portion of the digital file from the second user.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example application of different sensitivity labels to different portions of content, in accordance with embodiments of the present disclosure;

FIG. 3 illustrates a block diagram of an example application of different sensitivity labels to different portions of content, in accordance with embodiments of the present disclosure;

FIG. 4 illustrates a block diagram of an example application of different sensitivity labels to different portions of content, in accordance with embodiments of the present disclosure;

FIG. 5 illustrates a block diagram of an example application of different sensitivity labels to different portions of content, in accordance with embodiments of the present disclosure;

FIG. 6 illustrates a flow chart of an example process for applying different sensitivity labels to different portions of content, in accordance with embodiments of the present disclosure.

### DETAILED DESCRIPTION OF THE INVENTION

The present disclosure describes techniques for controlling user access to digital files on a more granular level. In particular, the techniques described herein enable portions of the content of a digital file to be labeled with sensitivity levels such that a user may be permitted to view one portion of the digital file, while another portion may be obfuscated or blurred when it is displayed them. When a user requests to view a document including different sensitivity labels, the system may determine which of the sensitivity levels the user is permitted to view based on a user context including attributes about the user (access privileges, etc.), an environmental context including information about the environment in which the user is requesting to view the digital file, and a file context including information about the file (author, users the file is shared with, etc.). Thus, as described in greater detail below, the present techniques provide for more granular control of access to digital and enable access to be based on the user's content, environment and their relationship to the digital file they wish to view.

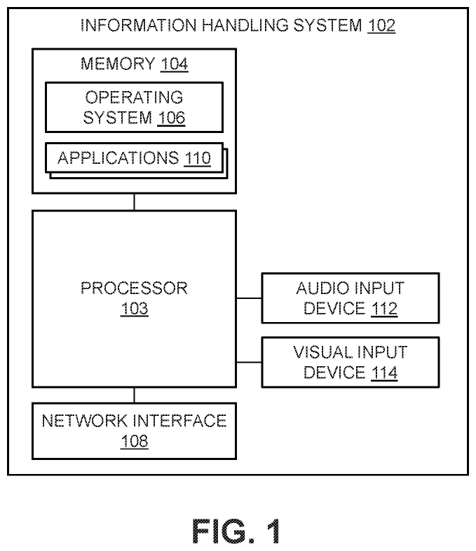

Preferred embodiments and their advantages are best understood by reference to FIGS. 1 through 6, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, and a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e. g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Memory 104 may also have stored thereon one or more applications 110. Each of the applications 110 may comprise any program of executable instructions (or aggregation of programs of executable instructions) configured to make use of the hardware resources of the information handling system 102, such as memory, processor time, disk space, input and output devices (e.g., 112, 114), and the like. In some implementations, the applications 110 may interact with the operating system 106 to make of the hardware resources, and the operating system 106 may manage and control the access of the applications 110 to these resources (as described above).

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In some embodiments, information handling system 102 may include more than one processor 103. For example, one such processor 103 may be a CPU, and other processors 103 may include various other processing cores such as application processing units (APUs) and graphics processing units (GPUS).

Information handling system 102 further includes an audio input device 112 communicatively coupled to processor 103. Audio input device 112 can be any device (e.g., a microphone) operable to detect audible signals (i.e., sound waves) in the environment external to the information handling system 102, and convert those audible signals into electrical signals. These electrical signals representing the detected audible signals can be provided to the processor 103 where they can be analyzed and interpreted, for example at the direction of applications 110 and/or operating system 106. In some cases, the audio input device 112 can be integrated into the information handling system 102, such as in the case of a built-in microphone. The audio input device 112 may also be an external device communicatively coupled to the information handling system 102, such as an external microphone connected via Universal Serial Bus (USB).

Information handling system 102 further includes an visual input device 114 communicatively coupled to processor 103. Visual input device 114 can be any device operable to detect electromagnetic radiation, such as visible light, and convert it into representative electrical signals. These electrical signals representing the detected electromagnetic radiation can be provided to the processor 103 where they can be analyzed and interpreted, for example at the direction of applications 110 and/or operating system 106. In some cases, the visual input device 114 can be complementary metal-oxide-semiconductor (CMOS) sensor, a charge coupled device (CCD) sensor, or another type of sensor operable to detect electromagnetic radiation. In some implementations, the visual input device 114 may be configured to detect a particular range of wavelengths of electromagnetic radiation, such as the visual light range, the ultraviolet range, the infrared range, or combinations of these and other ranges. In some cases, the visual input device 114 may be a low power camera device that monitors the environment while the information handling system 102 remains in a lower power state. In some implementations, the visual input device 114 can be integrated into the information handling system 102, such as in the case of a built-in camera. The visual input device 114 may also be an external device communicatively coupled to the information handling system 102, such as an external camera connected via USB.

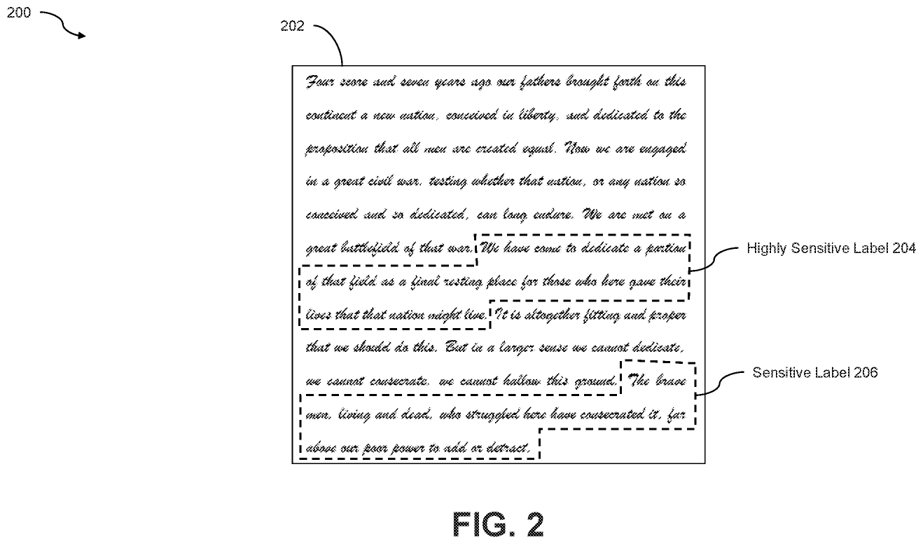

FIG. 2 illustrates a block diagram of an example application 200 of different sensitivity labels to different portions of content, in accordance with embodiments of the present disclosure. As shown, one portion of document 202 has been marked with a highly sensitive label 204, and another portion has been marked with a sensitive label 206. The highly sensitive label 204 and the sensitive label 206 represent two different levels of sensitivity. In some implementations, more levels of sensitivity may be used, and may thus be associated with corresponding labels denoting each level of sensitivity.

Document 202 is a digital document including content (in this case, text content). In some implementations, the sensitivity labels can be applied to portions of any digital file in any digital format, including, but not limited to, audio files, video files, text files, binary files, word processing documents, slideshows, spreadsheets, portable document format (PDF) documents, emails, and the like.

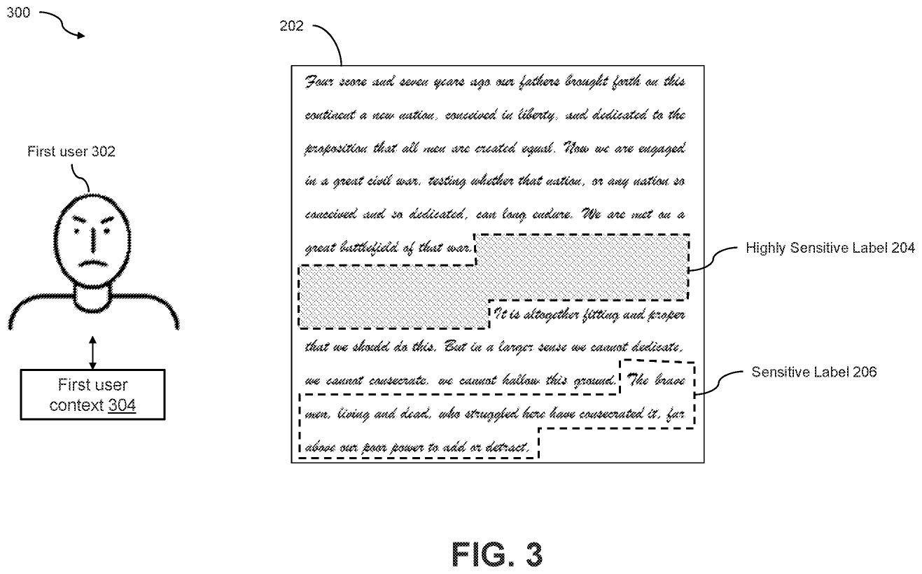

FIG. 3 illustrates a block diagram of an example application 300 of different sensitivity labels to different portions of content, in accordance with embodiments of the present disclosure. In particular, FIG. 3 shows a scenario when a first user 302 requests to view the document 202. As shown, the portion of the document 202 marked with the highly sensitive label 204 is obfuscated from the user, while the portion of the document marked with the sensitive label 206 is displayed.

The decision of which labeled portions of the document to show to the first user 302 is based at least in part on the first user context 304. The first user context 304 may include information about the user such as his access privileges or level, his membership in one or more user groups, his title within an organization, and other attributes. The computer system from which the first user requests the document 202 (not shown) considers the attributes in the first user context 304, and decides which portions of the document 202 the first user 302 is authorized to view and which portions must be hidden. For example, in the example of FIG. 3, the first user 302 may have had sufficient access privileges to authorize them to view the portion of the document 202 marked with the sensitive label 206, but insufficient access privileges to authorize them to view the portion of the document 202 marked with the highly sensitive label 204. In some implementations, the labels either encode these restrictions directly, or the restrictions may be stored in an external database record linked to the particular label, which the computer system retrieves when it receives a request to view the document 202.

In some implementations, the first user context also includes information about the environment in which the user is requesting to view the document 202. For example, the first user context 304 may indicate that the first user 302 is requesting to view the document 202 in an insecure location, such as a crowded café. The computer system may determine that the portions of the document 202 marked with the highly sensitive label 204 are too sensitive to risk viewing in such an unsecure location.

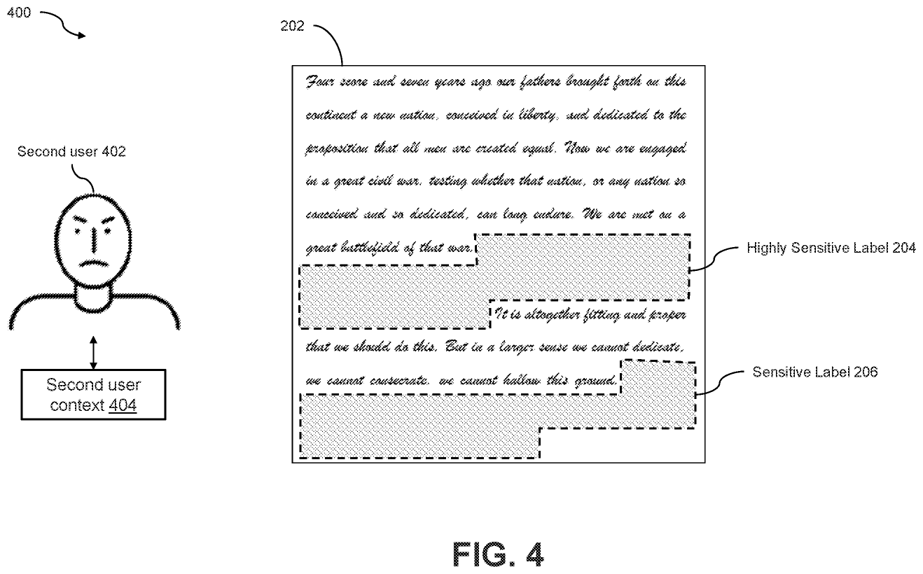

FIG. 4 illustrates a block diagram of an example application of different sensitivity labels to different portions of content, in accordance with embodiments of the present disclosure. In particular, FIG. 4 shows a scenario when a second user 402 requests to view the document 202. As shown, the portions of the document 202 marked with the highly sensitive label 204 and the sensitive label 206 are both obfuscated from the user. As discussed previously, the decision of whether to display or obfuscate the labeled portions of the document 202 is based at least in part on the second user context 404.

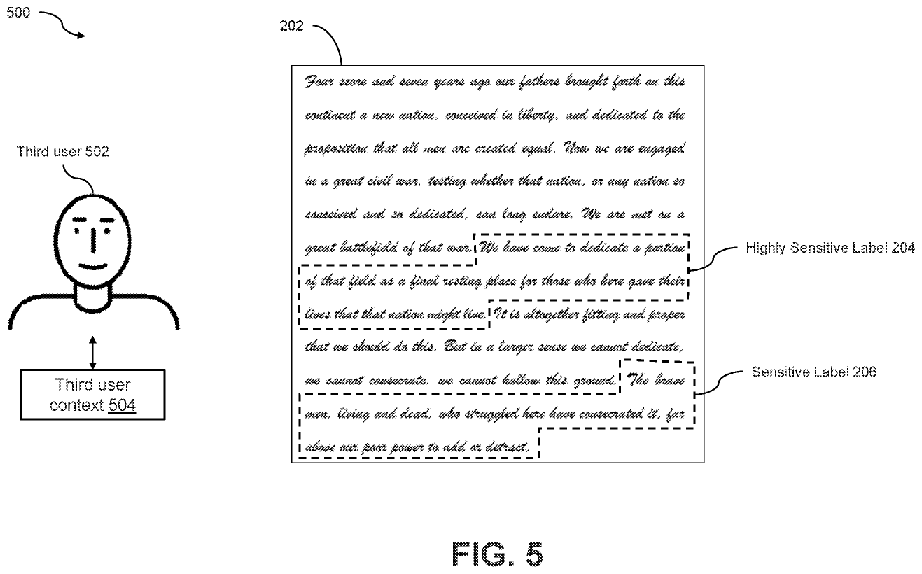

FIG. 5 illustrates a block diagram of an example application of different sensitivity labels to different portions of content, in accordance with embodiments of the present disclosure. In particular, FIG. 5 shows a scenario when a second user 402 requests to view the document 202. As shown, the portions of the document 202 marked with the highly sensitive label 204 and the sensitive label 206 are both displayed to the user. As discussed previously, the decision of whether to display or obfuscate the labeled portions of the document 202 is based at least in part on the second user context 504.

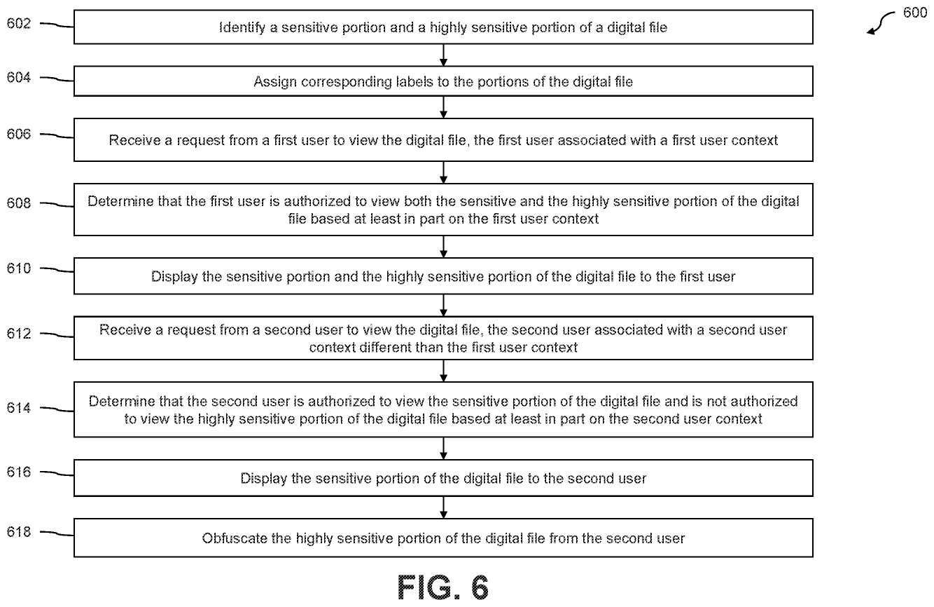

FIG. 6 illustrates a flow chart of an example process for applying different sensitivity labels to different portions of content, in accordance with embodiments of the present disclosure.

At 602, a sensitive portion and a highly sensitive portion of a digital file are identified, wherein content in the highly sensitive portion is more sensitive than content in the sensitive portion of the digital file. At 604, a highly sensitive label is assigned to the highly sensitive portion of the digital file, and a sensitive label to the sensitive portion of the digital file. At 606, a request is received from a first user to view the digital file, the first user associated with a first user context. At 608, it is determined that the first user is authorized to view both the sensitive portion and the highly sensitive portion of the digital file based at least in part on the first user context. At 610, the sensitive portion and the highly sensitive portion of the digital file are displayed to the first user. At 612, a request is received from a second user to view the digital file, the second user associated with a second user context different than the first user context. At 614, it is determined that the second user is authorized to view the sensitive portion of the digital file and is not authorized to view the highly sensitive portion of the digital file based at least in part on the second user context. At 616, the sensitive portion of the digital file is displayed to the second user. At 618, the highly sensitive portion of the digital file is obfuscated from the second user.

In some cases, obfuscating the highly sensitive portion of the digital file includes displaying a blurred representation of the highly sensitive portion.

In some cases, the first user context includes access privileges that are sufficient for viewing the highly sensitive portion of the digital file, and the second user context includes access privileges that are insufficient for viewing the highly sensitive portion of the digital file.

In some implementations, determining that the second user is not authorized to view the highly sensitive portion of the digital file is based at least in part on an environmental context included in the second user context and indicating that the second user is attempting to view the digital media file from an insecure location.

In some cases, determining that the first user is authorized to view both the sensitive portion and the highly sensitive portion of the digital file is based at least in part on a file context associated with the digital file.

In some implementations, the file context indicates at least one of the first user authoring the digital file, the first user being the owner of the digital file, or that the digital file is shared with the first user.

In some cases, the process 600 further includes receiving a request from a third user to view the digital file, the third user associated with a third user context different than the first and second user contexts; determining that the third user is not authorized to view the sensitive portion or the highly sensitive portion of the digital file based at least in part on the third user context; and obfuscating the sensitive portion and the highly sensitive portion of the digital file from the third user.

This encompasses disclosure all changes, substitutions, variations, alterations, and modifications to the exemplary embodiments herein that a person having ordinary skill n the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) o hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for applying different sensitivity labels to different portions of content, the method comprising:
identifying, by a computer system including at least one processor, a sensitive portion and a highly sensitive portion of a digital file, wherein content in the highly sensitive portion is more sensitive than content in the sensitive portion of the digital file;
assigning, by the computer system, a highly sensitive label to the highly sensitive portion of the digital file, and a sensitive label to the sensitive portion of the digital file;
receiving, by the computer system, a request from a first user to view the digital file, the first user associated with a first user context;
determining, by the computer system, that the first user is authorized to view both the sensitive portion and the highly sensitive portion of the digital file based at least in part on the first user context;
displaying, by the computer system, the sensitive portion and the highly sensitive portion of the digital file to the first user;
receiving, by the computer system, a request from a second user to view the digital file, the second user associated with a second user context different than the first user context;
determining, by the computer system, that the second user is authorized to view the sensitive portion of the digital file and is not authorized to view the highly sensitive portion of the digital file based at least in part on the second user context;
displaying, by the computer system, the sensitive portion of the digital file to the second user; and
obfuscating, by the computer system, the highly sensitive portion of the digital file from the second user.

2. The method of claim 1, wherein obfuscating the highly sensitive portion of the digital file includes displaying a blurred representation of the highly sensitive portion.

3. The method of claim 1, wherein the first user context includes access privileges that are sufficient for viewing the highly sensitive portion of the digital file, and the second user context includes access privileges that are insufficient for viewing the highly sensitive portion of the digital file.

4. The method of claim 1, wherein determining that the second user is not authorized to view the highly sensitive portion of the digital file is based at least in part on an environmental context included in the second user context and indicating that the second user is attempting to view the digital media file from an insecure location.

5. The method of claim 1, wherein determining that the first user is authorized to view both the sensitive portion and the highly sensitive portion of the digital file is based at least in part on a file context associated with the digital file.

6. The method of claim 5, wherein the file context indicates at least one of the first user authoring the digital file, the first user being the owner of the digital file, or that the digital file is shared with the first user.

7. The method of claim 1, further comprising:
receiving, by the computer system, a request from a third user to view the digital file, the third user associated with a third user context different than the first and second user contexts;
determining, by the computer system, that the third user is not authorized to view the sensitive portion or the highly sensitive portion of the digital file based at least in part on the third user context; and
obfuscating, by the computer system, the sensitive portion and the highly sensitive portion of the digital file from the third user.

8. A system for applying different sensitivity labels to different portions of content comprising:
a computer system including at least one processor and a memory, and configured to perform operations including:
identifying a sensitive portion and a highly sensitive portion of a digital file, wherein content in the highly sensitive portion is more sensitive than content in the sensitive portion of the digital file;
assigning a highly sensitive label to the highly sensitive portion of the digital file, and a sensitive label to the sensitive portion of the digital file;
receiving a request from a first user to view the digital file, the first user associated with a first user context;
determining that the first user is authorized to view both the sensitive portion and the highly sensitive portion of the digital file based at least in part on the first user context;
displaying the sensitive portion and the highly sensitive portion of the digital file to the first user;
receiving a request from a second user to view the digital file, the second user associated with a second user context different than the first user context;
determining that the second user is authorized to view the sensitive portion of the digital file and is not authorized to view the highly sensitive portion of the digital file based at least in part on the second user context;
displaying the sensitive portion of the digital file to the second user; and
obfuscating the highly sensitive portion of the digital file from the second user.

9. The system of claim 8, wherein obfuscating the highly sensitive portion of the digital file includes displaying a blurred representation of the highly sensitive portion.

10. The system of claim 8, wherein the first user context includes access privileges that are sufficient for viewing the highly sensitive portion of the digital file, and the second user context includes access privileges that are insufficient for viewing the highly sensitive portion of the digital file.

11. The system of claim 8, wherein determining that the second user is not authorized to view the highly sensitive portion of the digital file is based at least in part on an environmental context included in the second user context and indicating that the second user is attempting to view the digital media file from an insecure location.

12. The system of claim 8, wherein determining that the first user is authorized to view both the sensitive portion and the highly sensitive portion of the digital file is based at least in part on a file context associated with the digital file.

13. The system of claim 12, wherein the file context indicates at least one of the first user authoring the digital file, the first user being the owner of the digital file, or that the digital file is shared with the first user.

14. The system of claim 8, further comprising:
receiving a request from a third user to view the digital file, the third user associated with a third user context different than the first and second user contexts;
determining that the third user is not authorized to view the sensitive portion or the highly sensitive portion of the digital file based at least in part on the third user context; and
obfuscating the sensitive portion and the highly sensitive portion of the digital file from the third user.

15. An article of manufacture comprising a non-transitory, computer-readable medium having computer-executable instructions thereon that are executable by a processor of a computer system to perform operations for applying different sensitivity labels to different portions of content, the operations comprising:
identifying a sensitive portion and a highly sensitive portion of a digital file, wherein content in the highly sensitive portion is more sensitive than content in the sensitive portion of the digital file;
assigning a highly sensitive label to the highly sensitive portion of the digital file, and a sensitive label to the sensitive portion of the digital file;
receiving a request from a first user to view the digital file, the first user associated with a first user context;
determining that the first user is authorized to view both the sensitive portion and the highly sensitive portion of the digital file based at least in part on the first user context;
displaying the sensitive portion and the highly sensitive portion of the digital file to the first user;
receiving a request from a second user to view the digital file, the second user associated with a second user context different than the first user context;
determining that the second user is authorized to view the sensitive portion of the digital file and is not authorized to view the highly sensitive portion of the digital file based at least in part on the second user context;
displaying the sensitive portion of the digital file to the second user; and
obfuscating the highly sensitive portion of the digital file from the second user.

16. The article of claim 15, wherein obfuscating the highly sensitive portion of the digital file includes displaying a blurred representation of the highly sensitive portion.

17. The article of claim 15, wherein the first user context includes access privileges that are sufficient for viewing the highly sensitive portion of the digital file, and the second user context includes access privileges that are insufficient for viewing the highly sensitive portion of the digital file.

18. The article of claim 15, wherein determining that the second user is not authorized to view the highly sensitive portion of the digital file is based at least in part on an environmental context included in the second user context and indicating that the second user is attempting to view the digital media file from an insecure location.

19. The article of claim 15, wherein determining that the first user is authorized to view both the sensitive portion and the highly sensitive portion of the digital file is based at least in part on a file context associated with the digital file.

20. The article of claim 19, wherein the file context indicates at least one of the first user authoring the digital file, the first user being the owner of the digital file, or that the digital file is shared with the first user.
